(19) United States
(12) Patent Application Publication
(10) Pub. No.: US 2004/0189850 A1
(43) Pub. Date: Sep. 30, 2004

(54) Digital camera with detachable display module

(76) Inventor: Hui-Huang Chang, Hsinchu (TW)

Correspondence Address: BIRCH STEWART KOLASCH & BIRCH, PO BOX 747, FALLS CHURCH, VA, 22040-0747, US

(21) Appl. No.: 10/780,874

(22) Filed: Feb. 19, 2004

(30) Foreign Application Priority Data
Mar. 11, 2003 (TW) 92105152

(51) Int. Cl. H04N 5/222

(52) U.S. Cl. 348/333.07

(57) ABSTRACT

The present invention provides a digital camera having a detachable display module such that the display module can be selectively separated from the camera unit of the camera according to usages. In this regard, both the portability and the convenience of usage of the digital camera are enhanced. The digital camera of the present invention comprises: a camera unit for generating and outputting image data; and a display module capable of receiving the image data using a transmission interface and displaying the same; wherein, the display module is detachable from the camera unit.

### BACKGROUND OF THE INVENTION

(1). Field of the Invention

The present invention relates to a digital camera, and more particularly, to a digital camera with detachable display module.

(2). Description of the Prior Arts

Please refer to FIG. 1, which is a diagram depicting a framework of a conventional digital camera. As shown, the conventional digital camera 1 comprises: an image capture module 11 capable of capturing images; an image processor 12, connected to the image capture module 11 for processing the captured image and controlling the captured image; a storage medium 15, connected to the image processor 12 for storing processed images; a display module 13, connected to the image processor 12 for displaying the captured image or the image data stored in the storage medium 15; an I/O interface 14, connected to the image processor 12.

To simplify the description, a camera unit 19 is used for representing the assembly of the image capture module 11, the image processor 12, the I/O interface 14 and the storage medium 15 hereinafter. As to the display module 13 of the conventional digital camera 1, the liquid crystal display (LCD) is the most common implementation today, but not is limited to it. While taking a picture with the camera 1, the user first uses the display module 13 to find the image of interest, and then proceeds on filming with proper angle and composition by adjusting the camera 1 according to the image shown on the display module 13. Furthermore, after a picture is taken, the captured image can also be displayed using the display module 13. The display module 13 can be arranged on a side of the camera unit 19, as shown in FIG. 1B. Additionally, the display module 13 can also be connected to the camera unit 19 by an axle, such that the display module 13 can be flipped open, as shown in FIG. 1C.

However, a conventional digital camera 1 having a display module 13 irremovably affixed to a camera unit 19 occasionally suffers from inconvenience in operating. Since the display module 13 is irremovably affixed to the camera unit 19 that can not be separated from the camera 1, the position of the photographer and the surrounding geographical features can easily restrict the photographer from using the display module 13 in finding an image of interest and filming with proper angle and focal distance by adjusting the camera 1 according to the image shown on the display module 13.

For example, in order to take a close-up picture of a flower on the ground, the photographer usually has to move the lens (i.e., the image capture module 11) of the camera 1 close to the ground near the flower, which, in some circumstances, is difficult or even impossible to accomplish. Another example of restricted operation of the conventional camera 1 happens when filming a family picture and having no extra hand in helping taking the picture. As a typical approach which can be seen in the art, if the picture is taken using a digital camera with a display module capable of being rotated with 180 degrees as shown in FIG. 1C, though the photographer can still monitor the image of interest to avoid taking a skewed picture, the focal distance can be easily limited by the length of the photographer's arm reach. As another approach, if the picture is taken using a self-timer of the camera 1, the photographer usually has to maneuver in between the camera 1 and the other family members under limited time constrain. As a result, it is difficult for the photographer to capture an ideal image using the conventional digital camera 1.

### SUMMARY OF THE INVENTION

One of the many objects of the present invention is therefore to provide a digital camera having a detachable display module such that the display module can be selectively separated from the camera unit of the camera.

In order to achieve the aforementioned objects, a digital camera having a detachable display module is disclosed. The digital camera comprises a camera unit for generating and outputting image data; and a display module capable of receiving said image data using a transmission interface and displaying said image data; wherein the display module is detachable from the camera unit.

### BRIEF DESCRIPTION OF THE DRAWINGS

FIG. 1A is a diagram depicting a framework of a conventional digital camera.

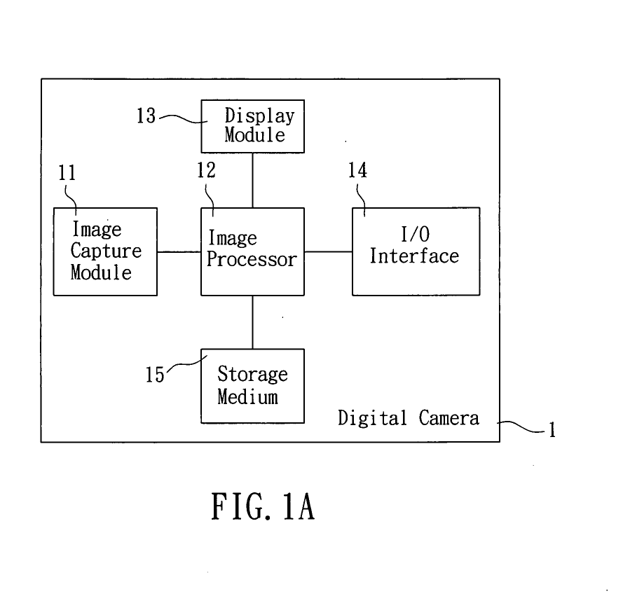

FIG. 1B is an embodiment of a conventional digital camera.

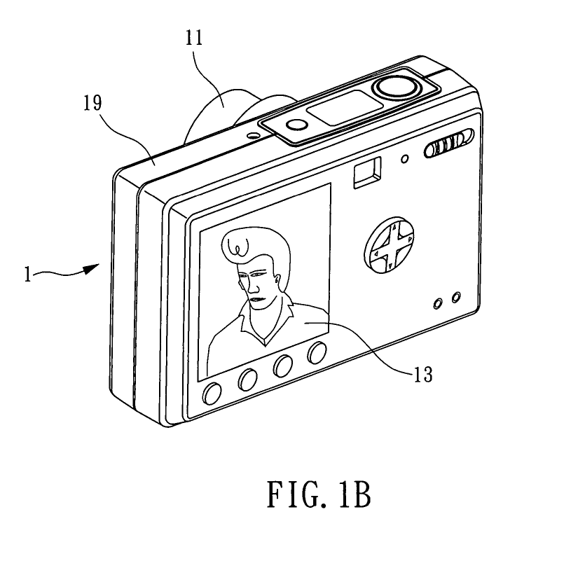

FIG. 1C is another embodiment of a conventional digital camera.

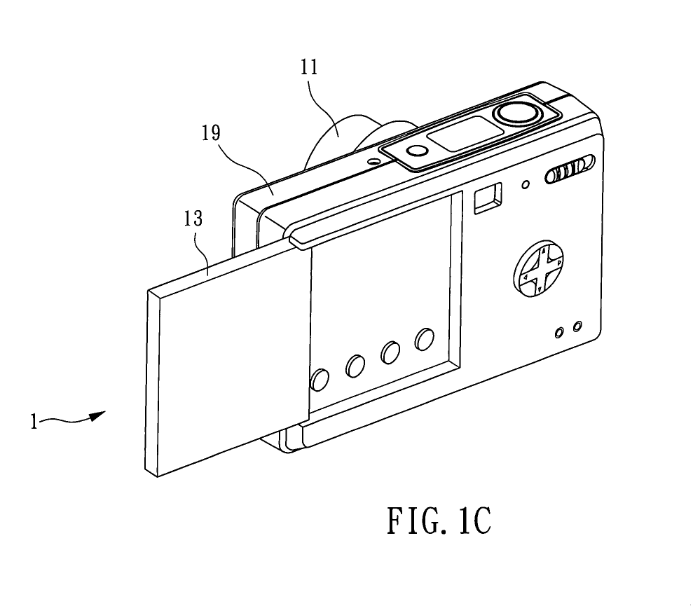

FIG. 2 is a diagram depicting a framework of a digital camera according to an embodiment of the present invention.

FIG. 3 is a diagram depicting the display module shown in FIG. 2 according to an embodiment of the present invention.

FIG. 4 is a diagram depicting the digital camera according to another embodiment of the present invention.

FIG. 5 is a diagram depicting the digital camera according to yet another embodiment of the present invention.

### DESCRIPTION OF THE PREFERRED EMBODIMENT

The objects, spirits and advantages of the embodiments of the present invention will be readily understood by the accompanying drawings and detailed descriptions, wherein:

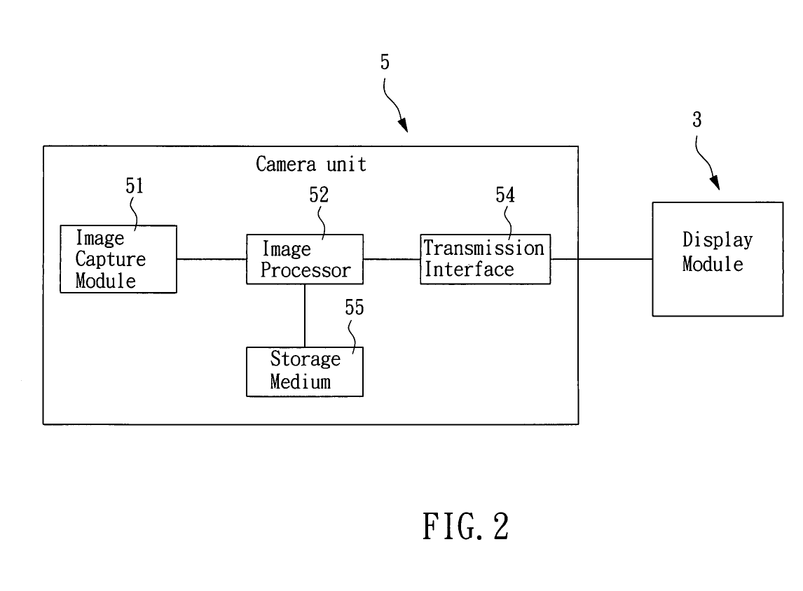

Please refer to FIG. 2, which is a diagram depicting a framework of a digital camera according to an embodiment of the present invention. The digital camera in FIG. 2 comprises: a camera unit 5 for generating and outputting image data, further including: an image capture module 51 for capturing images of interest; an image processor 52, connected to the image capture module 51 for processing the captured images and processing the captured images; a storage medium 55, connected to the image processor 52 for storing the processed images; and a transmission interface 54, connected to the image processor 52. The digital camera also comprises a display module 3 capable of receiving the image data using the transmission interface 54 and displaying the transmitted image data, wherein, the display module 3 is removably detachable from the camera unit 5.

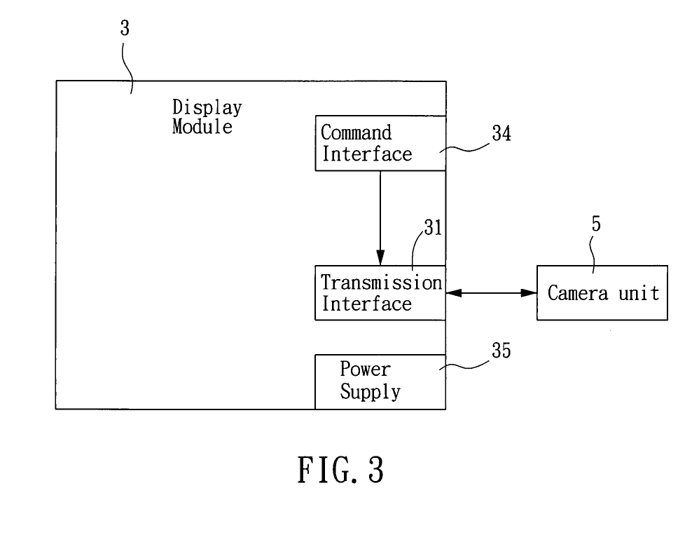

Please refer to FIG. 3, which is a diagram depicting the display module 3 shown in FIG. 2 according to an embodiment of the present invention. As shown in FIG. 3, the differences between the display module 3 and the display module 13 irremovably affixed to the camera unit 19 of a conventional digital camera 1 are: the display module 3 has a transmission interface 31 for interfacing communication between the display module 3 and the camera unit 5, moreover, the forgoing communications can be achieved either by wired transmission or by wireless transmission. Currently, the interfaces for achieving wired transmission include, but not limited to, optical fiber, Ethernet, USB, IEEE 1394, and parallel port, etc., and the wireless transmission can be accomplished using, but not limited to, infrared, Bluetooth™ or radio frequency (RF), etc.

In this embodiment, the display module 3 further comprises a command interface 34, which may comprise e.g. shuttle release, focus adjusting button, etc., such that a user can input commands using the command interface 34 on the display module for controlling the operation of the camera unit 5. In addition, the display module 3 further comprises a power supply 35 for supplying electricity to the display module 3. Generally, the power supply 35 may be implemented with a set of batteries. However, in some wired transmission embodiments the transmission interfaces respectively inside the display module 3 and the camera unit can also be used to transfer electricity from the camera unit 5 to the display module 3 for enabling the display module in using the power supply of the camera unit 5.

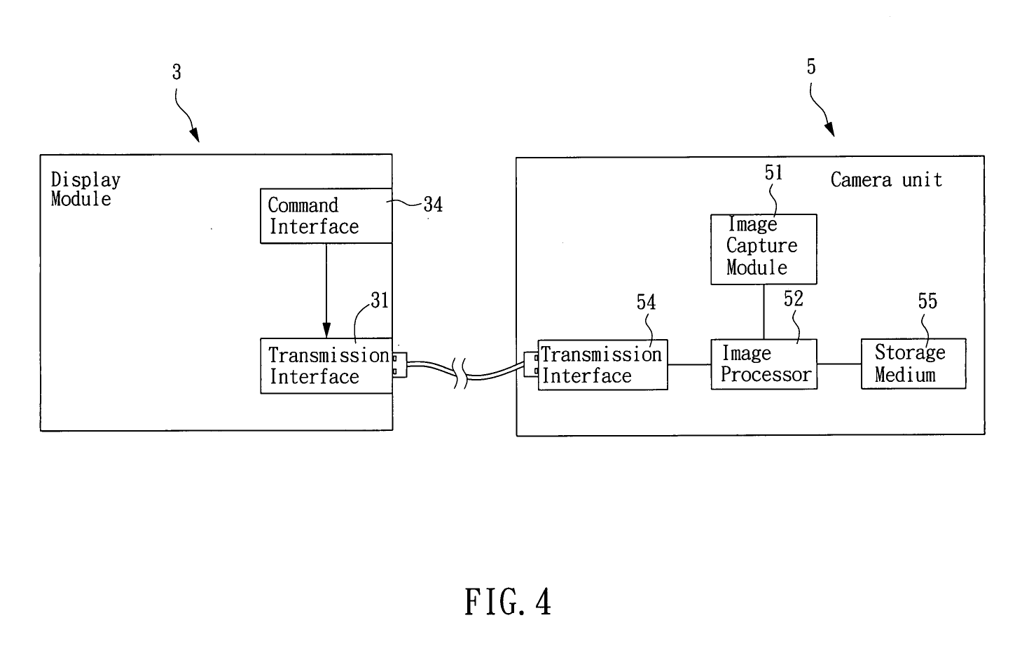

Please refer to FIG. 4, which is a diagram depicting the digital camera according to another embodiment of the present invention. The embodiment shown in FIG. 4 specifically illustrates the wired transmission between the camera unit 5 and the detachable display module 3. When using the digital camera in this embodiment for taking pictures, the detachable display module 3 can be detached from and then connected to the camera unit 5 through such wired transmission means so that the photographer can carry only the display module 3 and leave the camera unit 5 at an appropriate place for picture taking. For instance, while taking a close-up picture of a flower on the ground, the camera unit 5 can be placed on the ground at an appropriate location near the flower and the photographer can use the command interface 34 of the display module 3 to remotely control the image capture module 51 of the camera unit 5, e.g., use the shuttle release of the command interface 34 to enable a shot. In this regard, the position of the photographer and the surrounding geographical features will not have affect on the picture taking such that the convenience of usage is enhanced.

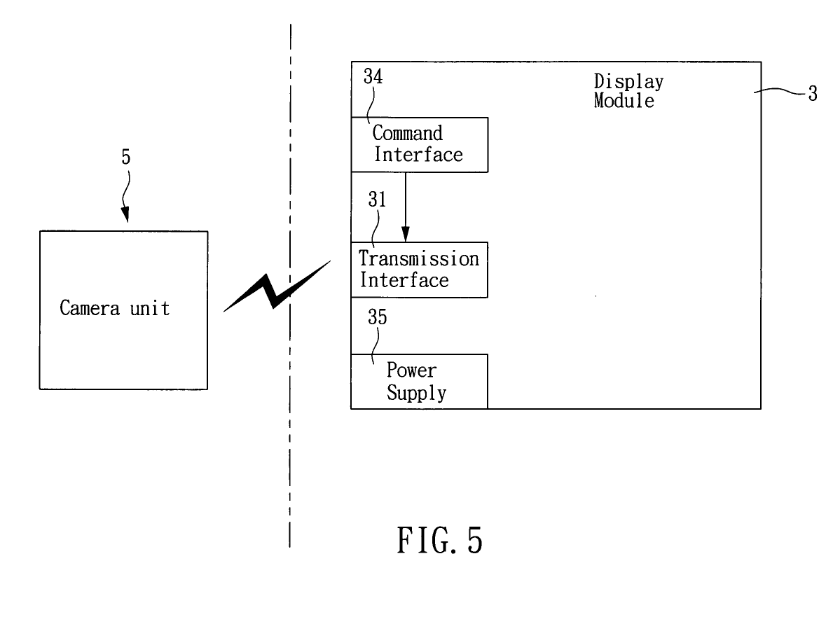

Please refer to FIG. 5, which is a diagram depicting the digital camera according to yet another embodiment of the present invention. Differentiating from the embodiment shown in FIG. 4, this embodiment shown in FIG. 5 specifically illustrates the wireless transmission between the camera unit 5 and the display module 3. In some situations, such as taking a family picture, this embodiment provides a digital camera having a camera unit 5 communicating with the display module 3 through wireless transmission, such that the photographer can operate on the detached display module 3 with ease for remotely controlling the camera unit 5 located in a certain distance away to take an ideal picture.

While the embodiments of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A digital camera, comprising:
a camera unit, for generating and outputting image data; and
a display module, capable of receiving said image data using a transmission interface and displaying said image data;
wherein, the display module is detachable from the camera unit.

2. The digital camera of claim 1, wherein said display module further comprises a command interface for controlling said digital camera.

3. The digital camera of claim 2, wherein said command interface includes a shuttle release.

4. The digital camera of claim 2, wherein said command interface includes an adjuster for adjusting focus.

5. The digital camera of claim 1, wherein said transmission interface is an interface adopting wired transmission

6. The digital camera of claim 5, wherein said wired transmission interface is a USB interface.

7. The digital camera of claim 5, wherein said wired transmission interface is an IEEE 1394 interface.

8. The digital camera of claim 5, wherein said wired transmission interface is an Ethernet interface.

9. The digital camera of claim 5, wherein said wired transmission interface is an optical fiber interface.

10. The digital camera of claim 5, wherein said wired transmission interface is a parallel port interface.

11. The digital camera of claim 1, wherein said transmission interface is an interface adopting wireless transmission.

12. The digital camera of claim 8, wherein said wireless transmission interface is an interface adopting infrared transmission.

13. The digital camera of claim 8, wherein said wireless transmission interface is an interface adopting Bluetooth™ technology.

14. The digital camera of claim 8, wherein said wireless transmission interface is an interface adopting radio frequency transmission.

15. The digital camera of claim 1, wherein said display module further comprises a power supply for providing electricity to said display module.

16. The digital camera of claim 1, wherein said display module is powered by a power supply of the camera unit through the transmission interface.
